(19) United States
(12) Patent Application Publication
(10) Pub. No.: US 2025/0106858 A1
(43) Pub. Date: Mar. 27, 2025

(54) METHOD AND APPARATUS OF BEAM INDICATION

(71) Applicant: Lenovo (Beijing) Limited, Beijing (CN)

(72) Inventors: Hongmei Liu, Beijing (CN); Zhi Yan, Beijing (CN); Yuantao Zhang, Beijing (CN); Ruixiang Ma, Beijing (CN); Haiming Wang, Beijing (CN)

(73) Assignee: Lenovo (Beijing) Limited, Beijing (CN)

(21) Appl. No.: 18/834,046

(22) PCT Filed: Feb. 10, 2022
(86) PCT No.: PCT/CN2022/075850

§ 371 Date: Jul. 29, 2024

(51) Int. Cl. H04W 72/23; H04W 72/044

(52) U.S. Cl. CPC H04W 72/23; H04W 72/046

(57) ABSTRACT

Embodiments of the present application are related to a method and apparatus of beam indication. According to an embodiment of the present application, an exemplary method includes: receive at least first spatial domain filter configuration information from a second RAN node; and perform at least one of the following: downlink transmission to a remote apparatus at least according to a first spatial domain filter; downlink reception from the second RAN node at least according to a second spatial domain filter; uplink reception from the remote apparatus at least according to a third spatial domain filter; or uplink transmission to the second RAN node at least according to a fourth spatial domain filter.

### TECHNICAL FIELD

Embodiments of the present application generally relate to wireless communication technologies, especially to a method and apparatus of beam indication.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In legacy release, to enable transmission and/or reception in a link between a base station (BS), e.g., gNB and a user equipment (UE), the gNB will indicate the UE a downlink (DL) reception or uplink (UL) transmission beam. When there is a repeater between the gNB and the UE, for each DL channel and reference signal (RS) and each UL channel and RS, the repeater needs to determine at least one of the reception beam and transmission beam for a link between the gNB and the repeater and determine at least one of the transmission beam and reception beam for a link between the repeater and the UE. Thus, how to indicate beam(s) to a repeater should be solved.

### SUMMARY OF THE DISCLOSURE

One objective of the present application is to provide a method and apparatus of beam indication, especially a method and apparatus of beam indication for a repeater or the like.

According to some embodiments of the present application, an exemplary RAN node e.g., a repeater includes: a transceiver; and at least one processor coupled to the transceiver, wherein the at least one processor is configured to: receive, via the transceiver, at least first spatial domain filter configuration information from a second RAN node; and perform at least one of the following: downlink transmission to a remote apparatus at least according to a first spatial domain filter; downlink reception from the second RAN node at least according to a second spatial domain filter; uplink reception from the remote apparatus at least according to a third spatial domain filter; or uplink transmission to the second RAN node at least according to a fourth spatial domain filter; wherein each of the first, the second, the third and the fourth spatial domain filter is determined based on the first spatial domain filter configuration information, or determined based on received second spatial domain filter configuration information, or is determined based on a fifth spatial domain filter indicated in the first spatial domain filter configuration information and a relationship with the fifth spatial domain filter.

In some embodiments of the present application, the first spatial domain filter configuration information indicates both the first spatial domain filter and the second spatial domain filter.

In some embodiments of the present application, the first spatial domain filter configuration information indicates both the third spatial domain filter and the fourth spatial domain filter.

In some embodiments of the present application, the first spatial domain filter configuration information is indicated by system information block (SIB), or radio resource control (RRC), or media access control (MAC) control element (CE).

In some embodiments of the present application, the first spatial domain filter and the second spatial domain filter are indicated in different ones of the first spatial domain filter configuration information and the second spatial domain filter configuration information. The first spatial domain filter is determined based on a downlink reception spatial domain filter configured by a signaling from the second RAN node to the remote apparatus.

In some embodiments of the present application, the third spatial domain filter and the fourth spatial domain filter are indicated in different ones of the first spatial domain filter configuration information and the second spatial domain filter configuration information. The third spatial domain filter is determined based on an uplink transmission spatial domain filter configured by a signaling from the second RAN node to the remote apparatus.

In some embodiments of the present application, the relationship is predefined or is configured by SIB, or RRC, or MAC CE to the RAN node.

In some embodiments of the present application, the fifth spatial domain filter is a downlink reception spatial domain filter configured by a signaling from the second RAN node to the remote apparatus, and the first spatial domain filter and the second spatial domain filter are determined based on a relationship with the fifth spatial domain filter. According to some embodiments of the present application, the first spatial domain filter, the second spatial domain filter and the fifth spatial domain filter are applied to at least one of physical downlink control channel (PDCCH), physical downlink shared channel (PDSCH), channel state information-reference signal (CSI-RS) or synchronization signal (SS)/physical broadcast channel (PBCH) block (SSB). According to some embodiments of the present application, the fifth spatial domain filter is a common spatial domain filter for only downlink, or for both downlink and uplink.

In some embodiments of the present application, in the case that the first spatial domain filter, the second spatial domain filter and the fifth spatial domain filter are applied to SSB, the first spatial domain filter, the second spatial domain filter and the fifth spatial domain filter are determined based on at least one time domain resource of the SSB.

In some embodiments of the present application, the fifth spatial domain filter is an uplink transmission spatial domain filter configured by a signaling from the second RAN node to the remote apparatus, and the third spatial domain filter and the fourth spatial domain filter are determined based on a relationship with the fifth spatial domain filter. According to some embodiments of the present application, the third spatial domain filter, the fourth spatial domain filter and the fifth spatial domain filter are applied to at least one of physical uplink control channel (PUCCH), physical uplink shared channel (PUSCH), sounding reference signal (SRS), Msg1, Msg3, or MsgA. According to some embodiments of the present application, the fifth spatial domain filter is a common spatial domain filter for uplink only, or for both downlink and uplink.

In some embodiments of the present application, in the case that the third spatial domain filter, the fourth spatial domain filter and the fifth spatial domain filter are applied to Msg1 or MsgA, the third spatial domain filter, the fourth spatial domain filter and the fifth spatial domain filter are determined based on corresponding time or frequency domain resource for Msg1 or MsgA and an association between CSI-RS or SSB and random access channel (RACH) occasion (RO).

In some embodiments of the present application, in the case that there are a plurality of spatial domain filters including the second spatial domain filter for downlink reception by the RAN node from the second RAN node and PDSCH repetition is scheduled by PDCCH, different PDSCH occasions are respectively associated with the plurality of spatial domain filters.

In some embodiments of the present application, panel selection in the RAN node is based on whether a spatial domain filter is for downlink reception or uplink transmission.

In some embodiments of the present application, the at least processor is configured to: in the case that there are two or more spatial domain filters indicated in a signaling, receive an indication signaling indicating whether the two or more spatial domain filters are used for different links of the RAN node or used for different resources in at least one of time domain, frequency domain or code domain for a link between the second RAN node and the RAN node. According to some embodiments of the present application, the different links are at least two of: at least one link between the second RAN node and the RAN node, at least one link between the RAN node and the remote apparatus, or at least one link between a third node to the RAN node. According to some embodiments of the present application, the indication signaling is RRC, or MAC CE.

In some embodiments of the present application, in the case that there are two or more spatial domain filters indicated in a signaling used for different links of the RAN node, the at least processor is configured to: associate each spatial domain filter with each link between the RAN node and the second RAN node, or between the RAN node and the remote apparatus based on a predefined or configured rule. According to some embodiments of the present application, the predefined or configured rule defines one of the following: associating each spatial domain filter and each link first in an order of upstream and downstream of the RAN node and then in an order of transmission configuration indication (TCI) state index associated with the second RAN node; or associating each spatial domain filter and each link first in an order of TCI state index associated with the second RAN node and then in an order of upstream and downstream of the RAN node. The upstream of the RAN node is the at least one link between the second RAN node and the RAN node, and the downstream of the RAN node is the at least one link between the RAN node and the remote apparatus.

In some embodiments of the present application, each of the first spatial domain filter, the second spatial domain filter, the third spatial domain filter, and the fourth spatial domain filter is associated with at least one of: CSI-RS, or SSB, or SRS, or TCI state, or joint TCI state, or spatial relation information.

According to some embodiments of the present application, an exemplary RAN node e.g., a repeater includes: a transceiver; and at least one processor coupled to the transceiver, wherein the at least one processor is configured to: determine at least one of the following: at least a first spatial domain filter for downlink communication from a first RAN node to a remote apparatus; at least a second spatial domain filter for downlink communication from the RAN node to the first RAN node; at least a third spatial domain filter for uplink communication from the remote apparatus to the first RAN node; or at least a fourth spatial domain filter for uplink communication from the first RAN node to the RAN node; and transmit, via the transceiver, at least first spatial domain filter configuration information to the first RAN node; wherein each of the first, the second, the third and fourth spatial domain filter is based on the first spatial domain filter configuration information, or based on transmitted second spatial domain filter configuration information, or is determined based on a fifth spatial domain filter indicated in the first spatial domain filter configuration information and a relationship with the fifth spatial domain filter.

Some embodiments of the present application also propose a method. An exemplary method may include: receive at least first spatial domain filter configuration information from a second RAN node; and perform at least one of the following: downlink transmission to a remote apparatus at least according to a first spatial domain filter; downlink reception from the second RAN node at least according to a second spatial domain filter; uplink reception from the remote apparatus at least according to a third spatial domain filter; or uplink transmission to the second RAN node at least according to a fourth spatial domain filter; wherein each of the first, the second, the third and the fourth spatial domain filter is determined based on the first spatial domain filter configuration information, or determined based on received second spatial domain filter configuration information, or is determined based on a fifth spatial domain filter indicated in the first spatial domain filter configuration information and a relationship with the fifth spatial domain filter

Given the above, embodiments of the present application provide a technical solution of beam indication for a RAN node, e.g., a repeater, and thus will facilitate the deployment and implementation of the NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 illustrates a schematic diagram of an exemplary wireless communication system in a non-multi-TRP scenario according to some embodiments of the present application.

FIG. 3 illustrates a schematic diagram of an exemplary wireless communication system in a multi-TRP scenario according to some other embodiments of the present application.

FIG. 4 a flow chart illustrating an exemplary procedure of a method of beam indication according to some embodiments of the present application.

FIG. 5 illustrates a block diagram of an exemplary apparatus of beam indication according to some embodiments of the present application.

FIG. 6 illustrates a block diagram of an exemplary apparatus of beam indication according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

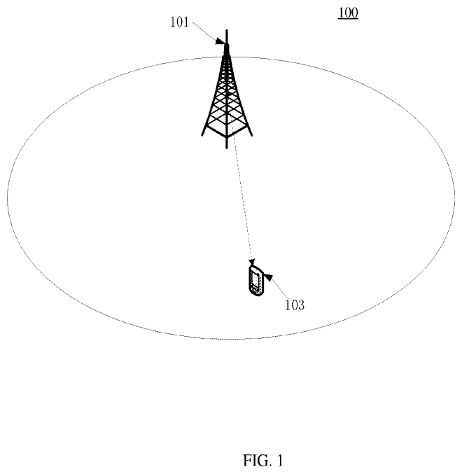

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one TRP (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

To enhance the coverage area of a BS, relay nodes, such as repeaters may be deployed in a wireless communication system, which can improve the throughput of a mobile device in low signal quality, e.g., a UE that locates in a coverage hole or far from the BS.

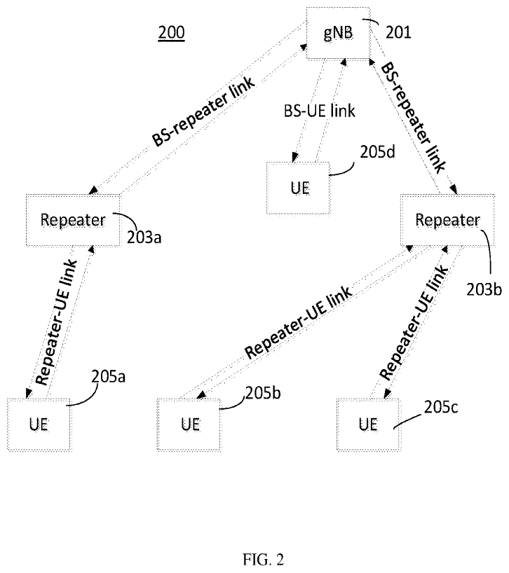

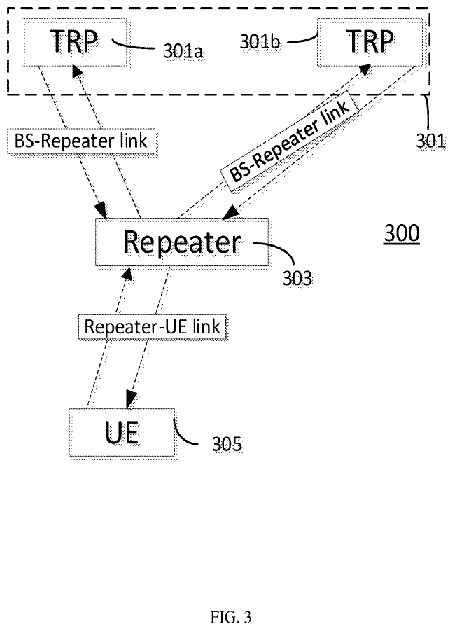

FIG. 2 and FIG. 3 respectively illustrate an exemplary scenario of a wireless communication system with repeaters, wherein FIG. 2 illustrates a schematic diagram of an exemplary wireless communication system 200 in a non-multi-TRP scenario according to some embodiments of the present application, and FIG. 3 illustrates a schematic diagram of an exemplary wireless communication system 300 in a multi-TRP scenario according to some other embodiments of the present application.

Referring to FIG. 2, in the exemplary wireless communication system 200, there are multiple nodes, e.g., a gNB 201, a first repeater 203a, a second repeater 203b, a first UE 205a, a second UE 205b, a third UE 205c and a fourth UE 205d. The gNB 201 may be configured with a single TRP or not. The first repeater 203a is connected with the gNB 201 and the first UE 205a, the second repeater 203b is connected with the gNB 201 and the second UE 205b and the third UE 205c. A link between a BS, e.g., the gNB 201 and a repeater, e.g., the first repeater 203a or the second repeater 203b can be referred to a BS-repeater link (or gNB-repeater link), a link between a repeater, e.g., the first repeater 203a and a UE, e.g., the first UE 205a can be referred to a repeater-UE link; and a link between a BS, e.g., the gNB 201 and a UE, e.g., the fourth UE 205d can be referred to as a BS-UE link (or gNB-UE link).

Persons skilled in the art should well know that each BS, e.g., the gNB 201 can connect with one or more repeaters, e.g., the first repeater 203a and second repeater 203b, and one or more UEs, e.g., the first UE 205a, the second UE 205b, the third UE 205c and the fourth UE 205d; and each repeater, e.g., the first repeater 203a and the second repeater 203b can connect with one or more BSs and one or more UEs. Thus, the exemplary nodes in the wireless communication system 200 with a limited number should not be deemed as the limitation to the present application.

Referring to FIG. 3, in the exemplary wireless communication system 300, there are multiple nodes, e.g., a gNB 301, a repeater 303 and a UE 305, wherein the gNB 301 is configured with (or associated with) two TRPs, e.g., a first TRP 301a and a second TRP 301b. The repeater 303 is connected with each of the first TRP 301a and the second TRP 301b. Thus, there two links between the gNB 301 and the repeater 303, one is a BS-repeater link (or gNB-repeater link, or TRP-repeater link) between the first TRP 301a and the repeater 303 and the other is a BS-repeater link (or gNB-repeater link, or TRP-repeater link) between the second TRP 301b and the repeater 303.

According to RP-213592, smart repeaters, which are transparent to UEs will be studied and identified. The smart repeaters can maintain the BS-repeater link and repeater-UE link simultaneously, and thus side control information including beamforming information is necessary for smart repeaters including assumption of max transmission power.

However, in legacy technology, a gNB indicates to a UE a DL reception beam and/or UL transmission beam for communication between the gNB and the UE. When there is a legacy repeater, which is not smart, between the gNB and the UE, the repeater needs to determine at least one of the reception beam and transmission beam for the BS-repeater link for each DL reception and UL transmission (e.g., for each DL or UL channel, or for each DL or UL RS in the BS-repeater link) and at least one of the transmission beam and reception beam for the repeater-UE link for each DL transmission and UL reception (e.g., for each DL or UL channel, or for each DL or UL RS in the repeater-UE link). That is, no side control information on beamforming is required by the legacy repeater. Accordingly, the industry needs a technical solution for solving the side control information, e.g., beamforming information to the smart repeaters or the like.

At least to solve the above technical problem, embodiments of the present application propose a technical solution of beam indication, e.g., a method and apparatus of beam indication, so that a smart repeater can determine beam(s) for transmission and reception in the BS-repeater link(s) and beam(s) for transmission and reception in the repeater-UE link(s).

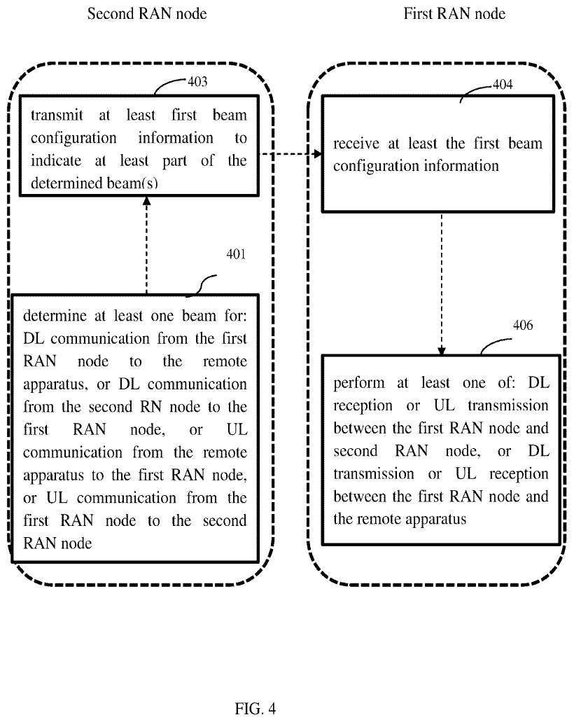

FIG. 4 is a flow chart illustrating an exemplary procedure of a method of beam indication according to some embodiments of the present application. Although the method is illustrated in a system level by a first RAN node, e.g., a repeater and a second RAN node, e.g., a BS, persons skilled in the art should understand that the method implemented in the two RAN nodes can be separately implemented and/or incorporated by other apparatus with the like functions.

As shown in FIG. 4, the first RAN node, e.g., a repeater is deployed between a second RAN node, e.g., a gNB and a remote apparatus, e.g., a UE, and may maintain at least one link between the first RAN node and the second RAN node, e.g., at least one BS-repeater link and at least one link between the first RAN node and the remote apparatus, e.g., at least one repeater-UE link simultaneously. The second RAN node will provide necessary side control information, e.g., beamforming information to the first RAN node. For example, the second RAN node will configure (or determine) beam(s) for at least a part of links of the first RAN node and indicate the beam configuration information (e.g., spatial domain filter configuration information) to the first RAN node, so that the first RAN node can determine beam(s) for the at least one link between the first RAN node and the second RAN node and for the at least one link between the first RAN node and the remote apparatus. Each beam for a RAN node or a remote apparatus is associated with a spatial domain transmission or reception filter, which is also associated with at least one RS. For example, each beam or spatial domain filter is associated with at least one of: CSI-RS, or SSB, or SRS, or TCI state, or joint TCI state, or spatial relation information etc. Each TCI state, or spatial relation information, or joint TCI state for at least one of downlink and uplink may be associated with one or two quasi co-located (QCL)-typeD RSs.

According to some embodiments of the present application, in step 401, the second RAN node may determine at least one of the following: at least a first spatial domain filter for downlink communication from the first RAN node to the remote apparatus; at least a second spatial domain filter for downlink communication from the second RAN node to the first RAN node; at least a third spatial domain filter for uplink communication from the remote apparatus to the first RAN node; or at least a fourth spatial domain filter for uplink communication from the first RAN node to the second RAN node.

The second RAN node can indicate the determined spatial domain filter(s) to the first RAN node in various manners, e.g., by a single signaling in a scheme, or by multiple signalings in another scheme etc., which will be specifically illustrated in following exemplary embodiments. In some embodiments of the present application, the second RAN node may also configure (or determine) spatial domain filter(s) for at least one of downlink and uplink communication between the second RAN node and the remote apparatus as legacy even if there is no BS-UE link therebetween, which may be indicated to the first RAN node first and then transferred to the remote apparatus by the first RAN node.

According to some embodiments of the present application, the second RAN node may transmit at least first spatial domain filter configuration information to the first RAN node in step 403, e.g., by SIB, or RRC, or MAC CE etc., which may directly indicate at least a part of the first, second, third and fourth spatial domain filters to the first RAN node, or indicate a fifth spatial domain filter for determining at least the part of the first, second, third and fourth spatial domain filters by the first RAN node. The second RAN node may further transmit second spatial domain filter configuration information to the first RAN node, which may directly indicate at least another part of the first, second, third and fourth spatial domain filter to the first RAN node. Accordingly, each of the first, second, third and fourth spatial domain filters can be based on the first spatial domain filter configuration information, or based on the second spatial domain filter configuration information, or can be determined based on the fifth spatial domain filter indicated in the first spatial domain filter configuration information and a relationship with the fifth spatial domain filter in various embodiments of the present application. The relationship can be predefined in specification or is configured by SIB, or RRC, or MAC CE etc., to the first RAN node. In the case that the first spatial domain filter, the second spatial domain filter and the fifth spatial domain filter are applied to SSB, the first spatial domain filter, the second spatial domain filter and the fifth spatial domain filter are determined based on at least one time domain resource.

In the first RAN node side, it will receive at least the first spatial domain filter configuration information in step 404. In step 406, the first RAN node will perform at least one of the following: downlink transmission to the remote apparatus at least according to the first spatial domain filter; downlink reception from the second RAN node at least according to the second spatial domain filter; uplink reception from the remote apparatus at least according to the third spatial domain filter; or uplink transmission to the second RAN node at least according to the fourth spatial domain filter. Consistent with the second RAN node side, the first RAN node can determine each of the first, second, third and fourth spatial domain filters based on the first spatial domain filter configuration information, or based on the second spatial domain filter configuration information, or based on the fifth spatial domain filter indicated in the first spatial domain filter configuration information and the relationship with the fifth spatial domain filter.

In a multi-TRP scenario, there has been more than one beam already according to legacy technology. For example, there are two TCI states for multi-TRP PDSCH transmission or multi-TRP PUSCH transmission, and the two TCI states can be associated with demodulation reference signal (DMRS) in one CDM group or two CDM groups. Thus, when the first RAN node, e.g., a repeater receives multiple beams, it has to differentiate whether the received multiple beams are for multi-TRP scenario (e.g., legacy multi-TRP scenario), or for different links of the first RAN node in non-multi-TRP scenario (e.g., the non-multi-TRP scenario as shown in FIG. 2), or for different links of the repeater in multi-TRP scenario (e.g., the multi-TRP scenario as shown in FIG. 3). In the case that the multiple beams are used for different links of the first RAN node, the first RAN node needs to determine for which link each beam is for. The different links are at least two of: at least one link between the second RAN node and the first RAN node, at least one link between the first RAN node and the remote apparatus, or at least one link between a third node to the first RAN node. The third node may be another RAN node, e.g., a gNB different from the second RAN node, another TRP or another remote apparatus. Taking FIG. 3 as an example, the different links are a DL between the first TRP 301a of the gNB 301 and a repeater 303, a UL between the first TRP 301a of the gNB 301 and the repeater 303, a DL between the second TRP 301b of the gNB 301 and the repeater 303, a UL between the second TRP 301b of the gNB 301 and the repeater 303, a DL between the repeater 303 and the UE 305, and a UL between the repeater 303 and the UE 305. Taking the second repeater 203b in FIG. 2 as an example, the different links are a DL between the gNB 201 and the second repeater 203b, a UL between the gNB 201 and the second repeater 203b, a DL between the second repeater 203b and the second UE 205b, a UL between the second repeater 203b and the second UE 205b, a DL between the second repeater 203b and the third UE 205c, and a UL between the second repeater 203b and the third UE 205c.

According to some embodiments of the present application, the second RAN node may directly indicate the first RAN node whether the multiple beams are used for different links of the first RAN node or not. For example, in the case that there are two or more spatial domain filters indicated in a signaling, an indication signaling may be transmitted by the second RAN node to the first RAN node, which indicates whether the two or more spatial domain filters are used for different links of the first RAN node or for links between different TRPs of the second RAN node and the first RAN node. The indication signaling can also indicate whether the two or more spatial domain filters are used for different links of the first RAN node or for different resources in at least one of time domain, frequency domain or code domain for a link between the second RAN node and the RAN node. Different resources in at least one of time domain, frequency domain or code domain for a link between the second RAN node and the first RAN node may be associated with different TRPs of the second RAN node, e.g., the different TRPs may share the same cell ID of the second RAN node. Taking FIG. 3 as an example, if there are two spatial domain filters indicated in a signaling, an indication signaling may be transmitted form the gNB 301 to the repeater 303, which indicates whether the two spatial domain filters are for the link between the gNB301 and the repeater 303 and the link between the repeater 303 and the UE 305 or the two spatial domains filters are for the link between the first TRP 301a and the repeater 303 and the link between the second TRP 301b and the repeater.

The indication signaling is RRC or MAC CE or other high layer signaling. For example, one bit may be used in a RRC or MAC CE to indicate that the multiple spatial domain filters are respectively used for different links of the first RAN node or used for different resources in at least one of time domain, frequency domain or code domain for a link between the second RAN node and the first RAN node. In some embodiments of the present application, the first RAN node is a repeater, the second node is a gNB, the remote apparatus is a UE, and two beams (two spatial domain filters) are indicated to the repeater. If the related bit in an indication signaling is “1,” the first beam of the two beams indicated to the repeater will be used for the gNB-repeater link and the second beam will be used for the repeater-UE link respectively; otherwise, if the related bit is “0,” the two beams will be used for resources in at least one of time domain, frequency domain or code domain for a gNB-repeater link of the repeater. For example, if the related bit is “0,” the first beam of the two beams will be used for a first time, frequency or code domain resource for a gNB-repeater link, and the second beam of the two beams will be used for a second time, frequency or code domain resource for a gNB-repeater link.

According to some other embodiments of the present application, the second RAN node may indirectly indicate the first RAN node whether the multiple beams are used for different links of the first RAN node or not. For example, in the case that there are two or more spatial domain filters indicated in a signaling and there is only one DMRS CDM group and no repetition in at least one of time domain or frequency domain is enabled or configured, the two or more spatial domain filters are used for different links of the first RAN node, i.e., the first spatial domain filter for gNB-repeater link, and the second spatial domain filter for repeater-UE link. In another example, in the case that there are a plurality of spatial domain filters configured for downlink reception by the first RAN node from the second RAN node and PDSCH repetition is scheduled or configured by PDCCH, the first RAN node will determine that different PDSCH in different time, frequency or code domain resources are respectively associated with the plurality of spatial domain filters.

In addition, in the case that there are two or more spatial domain filters indicated in a signaling to the first RAN node, a rule predefined in specification or configured in a high layer signaling, e.g., RRC or MAC CE, may be provided to associate each spatial domain filter with each link between the first RAN node and the second RAN node, or between the first RAN node and the remote apparatus. The second RAN node may include one or more TRPs. For example, the predefined or configured rule may define: associating each spatial domain filter and each link first in an order of upstream and downstream of the first RAN node, e.g., a repeater and then in an order of TRP index (e.g., represented by TCI state index) associated with the second RAN node, e.g., a gNB (if any). In another example, the predefined or configured rule may define: associating each spatial domain filter and each link first in an order of TRP index associated with the second RAN node, e.g., a gNB (if any) and then in an order of upstream and downstream of the first RAN node, e.g., a repeater. The upstream of the first RAN node is the at least one link between the second RAN node and the first RAN node and the downstream of the first RAN node is the at least one link between the first RAN node and the remote apparatus. Taking the repeater 303 in FIG. 3 as an example, if the order is TRP index first, upstream and downstream second, then the repeater 303 may first associate a plurality of spatial domain filters with the link(s) between the first TRP 301a and the repeater 303, then with the link(s) between the second TRP 301b, and then with the link(s) between the repeater 303 and the UE 305.

There may be multiple panels in the first RAN node. The first RAN node may make the panel selection based on whether a spatial domain filter is for downlink reception or uplink transmission. That is, different panels may be associated with different links. For example, the first panel is for gNB-repeater link and the second panel is for repeater-UE link. In an exemplary multi-TRP scenario, there are three beams indicated to a repeater, e.g., 3 QCL-typeD RSs. The first QCL-typeD RS is for DL between a first TRP and the repeater, the second QCL-typeD RS is for DL between a second TRP and the repeater, and the third QCL-typeD RS is for DL between the repeater and a UE. Then, the repeater will select the first panel for DL transmission from the repeater to the UE with the third QCL-typeD RS, or select the second panel for DL reception from the first TRP with the first QCL-typeD RS or for DL reception from the second TRP with the second QCL-typeD RS.

Persons skilled in the art should well know that herein (throughout the specification), the wordings, such as the first, the second, the third, the fourth and the fifth etc., are only used to distinguish similar features or elements etc., for clearness, and should not be deemed as limitation to the scope of the technical solutions.

Hereafter, taking a repeater as an example of the first RAN node, taking a gNB as an example of the second RAN node, and taking a UE as an example of the remote apparatus, more details on how to configure and indicate the spatial domain filter configuration information (beam configuration information) to the first RAN node by the second RAN node and the first RAN node determines the related beam will be illustrated below in view of various exemplary embodiments of the present application. Persons skilled in the art should well know that the illustrated solutions can also be applied to other nodes with the like functions in a wireless communication system.

### Scheme 1

Scheme 1 can be applied to control resource set (CORSET) TCI state configuration to determine PDCCH beam, or applied to PDSCH TCI state configuration to determine PDSCH beam, or applied to CSI-RS spatial domain filter configuration or PUSCH TCI state configuration or SRS spatial relation information configuration or PUCCH spatial relation information configuration or joint TCI state to determine beam(s) for at least one of downlink and uplink. The related beam information (or beam configuration information) can be indicated in SIB, or RRC, or MAC CE by adding new bits to legacy release in some embodiments of the present application, or can be indicated in SIB, or RRC, or MAC CE by using reserved bit(s) in the legacy release to be transparent to the UE.

According to some embodiments of the present application, the gNB may send a single signaling to indicate the beams for all links of the repeater, e.g., in the case of a common beam or joint beam(s) being configured. According to some other embodiments of the present application, the gNB may separately configure DL and UL beams for each link of the repeater. For each downlink between the gNB and repeater and between the repeater and UE, the gNB may indicate the beam(s) to the repeater in a single signaling (or single spatial domain filter configuration information); and for each uplink between the gNB and repeater and between the repeater and UE, the gNB may indicate the beam(s) to the repeater in another single signaling (or other single spatial domain filter configuration information). The gNB can also indicate both downlink and uplink between the gNB and repeater and between the repeater and UE in a single signaling. The single signaling can be based on a joint TCI state indication.

Taking the first repeater 203a shown in FIG. 2 as an example, for downlink communication, the gNB 201 may indicate a first beam (e.g., the first spatial domain filter) for downlink communication between the first repeater 203a and the first UE 205a and a second beam (e.g., the second spatial domain filter) for downlink communication between the gNB 201 and the first repeater 203a in a single signaling, e.g., a first signaling indicating first spatial domain filter configuration information or a second signaling indicating second spatial domain filter configuration information etc.

In some embodiments of the present application, the gNB may predefine or preconfigure one or more sets (or pairs, or groups etc.) of beams for downlink communication on each link between the gNB and the repeater and between the repeater and UE. The gNB may select (or determine, or configure) one set of beams for the repeater, e.g., by indicating the index of the set of beam. Still taking the first repeater 203a as an example, Table 1 illustrates an exemplary spatial domain filter configuration information preconfigured by the gNB 201 for the downlink communication between the gNB 201 and the first repeater 203a and between the first repeater 203a and first UE 205a. The first set of beams, e.g., Set Index #1 includes SSB #3 for downlink communication between the gNB 201 and the first repeater 203a and CSI-RS #6 for downlink communication between the first repeater 203a and the first UE 205a; and the second set of beams, e.g., Set Index #2 includes CSI-RS #1 for downlink communication between the gNB 201 and the first repeater 203a and CSI-RS #2 for downlink communication between the first repeater 203a and the first UE 205a.

TABLE 1

| | Reception beam | DL transmission |
|---|---|---|
| QCL-typeD | for gNB-repeater | beam for repeater- |
| DL RS set | link at repeater | UE link at repeater |
| Set Index#1: | SSB#3 | CSI-RS#6 |
| SSB#3, CSI-RS#6 | | |
| Set Index#2: | CSI-RS#1 | CSI-RS#2 |
| CSI-RS#1, CSI-RS#2 | | |

The gNB 201 may indicate Set Index #1 to the first repeater 201a. Then, the first repeater 201 will use SSB #3 to determine the spatial domain filter for downlink reception from the gNB 201 and use CSI-RS #6 to determine the spatial domain filter for downlink transmission to the first UE 205a.

Similarly, for uplink communication, still taking the first repeater 203a shown in FIG. 2 as an example, the gNB 201 may indicate a third beam (e.g., the third spatial domain filter) for uplink communication between the first repeater 203a and the first UE 205a and a fourth beam (e.g., the fourth spatial domain filter) for uplink communication between the gNB 201 and the first repeater 203a in a single signaling, e.g., a first signaling indicating first spatial domain filter configuration information or a second signaling indicating second spatial domain filter configuration information etc.

In some embodiments of the present application, the gNB may predefine or preconfigure one or more sets (or pairs, or groups etc.) of beams for uplink communication on each link between the gNB and the repeater and between the repeater and UE. The gNB may select (or determine, or configure) one set of beam for the repeater, e.g., by indicating the index of the set of beams. Still taking the first repeater 203a shown in FIG. 2 as an example, Table 2 illustrates an exemplary spatial domain filter configuration information preconfigured by the gNB 201 for the uplink communication between the gNB 201 and the first repeater 203a and between the first repeater 203a and first UE 205a. The first set of beams, e.g., Set Index #1 includes SRS #1 for uplink communication between the gNB 201 and the first repeater 203a and SRS #5 for uplink communication between the first repeater 203a and the first UE 205a; and the second set of beams, e.g., Set Index #2 includes SRS #2 for uplink communication between the gNB 201 and the first repeater 203a and SRS #4 for uplink communication between the first repeater 203a and the first UE 205a.

TABLE 2

| | UL | UL |
|---|---|---|
| | transmission | reception |
| | beam | beam |
| QCL-typeD | for gNB-repeater | for repeater-UE |
| UL RS set | link at repeater | link at repeater |
| Set Index#1: | SRS#1 | SRS#5 |
| SRS#1, SRS#5 | | |
| Set Index#2: | SRS#2 | SRS#4 |
| SRS#2, SRS#4 | | |

The gNB 201 may indicate Set Index #2 to the first repeater 201a. Then, the first repeater 201 will use SRS #2 to determine the spatial domain filter for uplink transmission to the gNB 201 and use SRS #4 to determine the spatial domain filter for uplink reception from the first UE 205a.

The indicated set index can also be used for both downlink and uplink between the gNB and repeater and between the repeater and UE. If Set Index #1 in Table 2 is indicated, and if the indicated set index is applied to both DL and UL, then the spatial domain filter for both downlink and uplink for the gNB-repeater link is determined based on SRS #1, and the spatial domain filter for both downlink and uplink for the repeater-UE link is determined based on SRS #5.

### Scheme 2

Scheme 2 can also be applied to CORSET TCI state configuration to determine PDCCH beam, or applied to PDSCH TCI state configuration to determine PDSCH beam, or applied to CSI-RS spatial domain filter configuration or PUSCH TCI state configuration or SRS spatial relation information configuration or PUCCH spatial relation information configuration or joint TCI state to determine beam(s) for at least one of downlink and uplink. The related beam information can be indicated in SIB, or RRC, or MAC CE. For the UE, it can determine the beams as the same as in legacy technology.

As stated above, the repeater will also receive the beam configuration information transmitted from the gNB to the UE, which is consistent with that for link(s) between the repeater and UE. That is, the beam configuration information is to indicate UE the DL reception beam or UL transmission beam, and actually, the DL communication to UE and UL communication from UE is performed by the repeater. So for both the DL and UL communication from the repeater to UE, the transmission side and the reception side will have common understanding of the spatial domain filter. For example, if a DL reception spatial domain filter is indicated by gNB to UE (via a repeater), then the DL spatial transmission domain filter at the repeater for the repeater-UE link is consistent with the indicated DL spatial reception domain filter, e.g., by being associated with the same RS. Thus, the repeater can determine the beams for link(s) between the repeater and UE based on the beam configuration information transmitted from gNB to UE. So the repeater can derive the spatial domain filter for the repeater-UE link via the indication from the gNB to UE, as the signaling needs to be forwarded by the repeater. For links between the gNB and repeater, another signaling (or beam configuration information) will be provided by the gNB to the repeater. That is, even both for DL communication, beams for downlink(s) between gNB and repeater and downlink(s) between repeater and UE are indicated in different signalings or different beam configuration information in Scheme 2. Similarly, even both for UL communication, beams for uplink(s) between gNB and repeater and uplink(s) between repeater and UE are indicated in different signalings or different beam configuration information in Scheme 2.

For example, taking the first repeater 203 as shown in FIG. 2 as an example, for downlink communication, the first repeater 203 may determine a first beam (e.g., the first spatial domain filter) for downlink communication between the first repeater 203a and the first UE 205a based on a downlink reception spatial domain filter configured by a signaling (e.g., a first signaling indicating first spatial domain filter configuration information or a second signaling indicating second spatial domain filter configuration information etc.) from the gNB 201 to the first UE 205a. The gNB 201 may also indicate a second beam (e.g., the second spatial domain filter) for downlink communication between the gNB 201 and the first repeater 203a in another signaling, e.g., a first signaling indicating first spatial domain filter configuration information or a second signaling indicating second spatial domain filter configuration information etc. That is, the first spatial domain filter and the second spatial domain filter are indicated in different spatial domain filter configuration information.

Similarly, for uplink communication, still taking the first repeater 203a shown in FIG. 2 as an example, the first repeater 203 may determine a third beam (e.g., the third spatial domain filter) for uplink communication between the first repeater 203a and the first UE 205a based on a uplink reception spatial domain filter configured by a signaling (e.g., a first signaling indicating first spatial domain filter configuration information or a second signaling indicating second spatial domain filter configuration information etc.) from the gNB 201 to the first UE 205a. The gNB 201 may further indicate a fourth beam (e.g., the fourth spatial domain filter) for uplink communication between the gNB 201 and the first repeater 203a in another signaling, e.g., a first signaling indicating first spatial domain filter configuration information or a second signaling indicating second spatial domain filter configuration information etc.

Similar to legacy, per possible links, the gNB may predefine or preconfigure one or more set of joint or separate beams for DL communication and UL communication between the gNB and the repeater and between the repeater and UE. For each beam to be indicated to the UE or the repeater, the gNB may indicate a beam index from a corresponding set of beams to the repeater or the UE (transferred by the repeater), so that the repeater can determine the related beam information based on the beam index indicated to the UE by the gNB or the indicated beam index to the repeater itself.

### Scheme 3

In Scheme 3, at least part of beams for different link(s) of a repeater is determined based on an indicated beam (e.g., the fifth spatial domain filter) and the relationship with the indicated beam. The relationship can be predefined or is configured by SIB, or RRC, or MAC CE to the repeater. The relationship can also be predefined or configured by SIB, RRC or MAC CE to the UE.

In some embodiments of the present application, Scheme 3 can be applied to DL communication, e.g., at least one of: PDCCH, PDSCH, CSI-RS or SSB. The fifth spatial domain filter can be a downlink reception spatial domain filter configured by a signaling from the gNB to the repeater or to the UE, e.g., a common spatial domain filter for only downlink, or for both downlink and uplink. Based on the fifth spatial domain filter and the predefined or configured relationship, the repeater can determine the spatial domain filter (e.g., the first spatial domain filter), e.g. CSI-RS, SSB, or SRS for the downlink transmission from the repeater to the UE and the spatial domain filter (e.g., the second spatial domain filter) for downlink reception from the gNB by the repeater.

Similar to Scheme 1, the gNB may predefine or preconfigure one or more relationship between a RS configured from the gNB to UE and at least one RS for the gNB-repeater link and repeater-UE link as shown in Table 3. The RS can be associated with DL or UL or joint TCI state. The relationship is between one RS and a pair of RSs. The one RS is transmitted from the gNB to UE, and the pair of RSs is for the gNB-repeater link and repeater-UE link, respectively. The gNB may indicate a beam configured for downlink reception at the UE by a signaling to the UE (transferred by the repeater), so that the repeater can determine the related beam information based on the indicated beam and relationship, because the repeater can also receive the beam for the downlink reception at UE.

TABLE 3

| | Reception beam | DL transmission |
|---|---|---|
| QCL-typeD DL RS | for gNB-repeater | beam for repeater- |
| to UE by gNB | link at repeater | UE link at repeater |
| SSB#1 | SSB#3 | CSI-RS#6 |
| CSI-RS#3 | CSI-RS#1 | CSI-RS#2 |

For example, the gNB may indicate SSB #1 to the UE as the DL reception by a signaling. When receiving the signaling, the repeater will determine the DL reception beam for the gNB-repeater link based on SSB #3 and the DL transmission beam for repeater-UE link based on CSI-RS #6 based on the signaling and the relationship. Meanwhile, UE can also determine the DL reception beam for itself based on CSI-RS #6.

For the UE, after receiving the DL beam from gNB to UE, it can determine the beam for repeater-UE link, an accordingly the reception beam for repeater-UE link will be determined. In this case, since the received DL beam is as the same as in legacy release, an indication will be transmitted to the UE, indicating whether a received spatial domain filter is used as the fifth spatial domain filter or for determination of the first spatial domain filter and the second spatial domain filter based on the relationship. For example, one bit in a high layer signaling or dynamic signaling will indicate whether the beam is for UE reception or transmission or a transformation based on the relationship is necessary to determine the beam for UE reception or transmission on repeater-UE link.

When Scheme 3 is applied to PDCCH, beam(s) for PDCCH configured by a signaling from the gNB to the UE is configured per CORESET. Based on the relationship and the TCI state configuration in CORESET, at the repeater side, the beam(s) for PDCCH reception (from the gNB) for the gNB-repeater link and PDCCH transmission (to the UE) for repeater-UE link is determined. Meanwhile, at the UE side, beam(s) for the PDCCH reception can also be determined.

When Scheme 3 is applied to PDSCH, beam(s) configured by a signaling from the gNB to the UE may be indicated in PDCCH in some cases. Thus, at the repeater side, the beam for PDSCH transmission to the UE for the repeater-UE link and reception from the gNB in the repeater for the gNB-repeater link can be determined based on the relationship and the indicated beam. Meanwhile, at the UE side, beam(s) for PDSCH reception can also be determine based on TCI state in the PDCCH and the relationship. For SPS PDSCH, at the repeater side, the PDCCH for activation is used to determine SPS PDSCH beam(s) for the repeater for both the gNB-repeater link and repeater-UE link. At the UE side, the SPS PDSCH reception beam and the relationship is used to determine the SPS PRSCH reception beam. In some other cases, PDSCH beam(s) for UE may be implicitly determined by the beam of the lowest COREST ID (identity or index), the lowest indexed PUCCH resource, or the lowest TCI state in PDSCH TCI list. Based on the relationship and the default beam, beam(s) for PDSCH transmission and reception in the repeater and reception beam for PDSCH in the UE can also be determined accordingly in a similar manner as PDCCH or other kinds of PDSCH. In some yet other cases, there may be PDSCH repetition scheduled by a PDCCH. For example, two beams will be indicated in PDCCH, and they are applied to different PDSCH time or frequency or code domain occasions. With the relationship, at the repeater side, different PDSCH occasions may be associated with different beams at the repeater for both the gNB-repeater link and repeater-UE link based on the indicated beam and the relationship. At the UE side, different PDSCH reception beam will also be associated with different PDSCH occasions based on the indicated beam and the relationship.

Regarding phase tracking reference signal (PTRS) or DMRS in the repeater and UE respectively, they will use the same beam(s) as the corresponding PDSCH or PDCCH or PUSCH or PUCCH. If Scheme 3 is adopted, beam(s) for PTRS and DMRS is also based on the associated beam and the relationship.

When Scheme 3 is applied to CSI-RS, beam(s) from the gNB to UE may be configured by RRC signaling from the gNB to the UE (via the repeater). Accordingly, beam(s) for CSI-RS reception and transmission in the repeater for both the gNB-repeater link and repeater-UE link is determined based on the configured beam and the relationship. At the UE side, the reception beam of CSI-RS can also be determined based on the configured beam and the relationship.

When Scheme 3 is applied to SSB, different beam(s) may be associated with different time domain resources per SSB pattern definition in TS 38.213. Accordingly, beam(s) for SSB reception and transmission in the repeater for both the gNB-repeater link and repeater-UE link is determined based on the SSB index and the relationship. Since different SSB indexes are associated with different time domain resources, it can also be considered that beam(s) for SSB reception and transmission in the repeater for both the gNB-repeater link and repeater-UE link is determined based on different time domain resources for SSB and the relationship. At the UE side, the reception beam for SSB can be determined based on the SSB index and the relationship, or alternatively, determined based on the time domain resource of the SSB and the relationship.

In some other embodiments of the present application, Scheme 3 can be applied to UL communication, e.g., PUCCH, PUSCH, SRS, or RACH/physical random access channel (PRACH) message (e.g., MSG1 or Msg3, or MsgA) etc. The fifth spatial domain filter can be an uplink transmission spatial domain filter configured by a signaling from the gNB to the UE, e.g., a common spatial domain filter for only uplink, or for both downlink and uplink. Based on the fifth spatial domain filter and the predefined or configured relationship, the repeater can determine the spatial domain filter (e.g., the third spatial domain filter), e.g. CSI-RS, SSB, or SRS for the uplink transmission from the UE to the repeater and the spatial domain filter (e.g., the fourth spatial domain filter) for uplink transmission from the repeater to the gNB.

Similarly, the gNB may predefine or preconfigure one or more relationships between a joint or separate beams for UL communication from UE to the gNB and at least one beam for the UL transmission or reception for the gNB-repeater link and for the repeater-UE link as shown in Table 4. The gNB may indicate a beam configured for uplink transmission to the UE from a set of beams by a signaling to the UE (transferred by the repeater), so that at the repeater side, it can determine the related beam information based on the indicated beam and relationship for the gNB-repeater link and for the repeater-UE link. At the UE side, it can also determine the beam for UL transmission based on the indicated beam and the relationship. Similarly to DL, a signaling can be configured to UE on how to interpret the beam indication, i.e., whether the UL transmission beam for UE is determined based on the indication beam directly or is determined based on the indicated beam and the relationship. DL communication can contain at least one of DL transmission and DL reception. UL communication can contain at least one of UL transmission and UL reception.

TABLE 4

| | UL transmission | UL |
|---|---|---|
| QCL-typeD | beam for gNB- | reception beam |
| UL RS | repeater link | for repeater-UE |
| to UE by gNB | at repeater | link at repeater |
| SRS#3 | SRS#1 | SRS#5 |
| SRS#1 | SRS#2 | SRS#4 |

For example, the gNB may indicate SRS #3 to the UE as the beam for UL transmission by a signaling. When receiving the signaling, the repeater will determine the UL transmission beam for gNB-repeater link based on SRS #1 and the UL reception beam for repeater-UE link based on SRS #5 based on the signaling and the relationship. At the UE side, UE will determine the UL transmission beam based on SRS #5, which is actually for the repeater-UE link.

When Scheme 3 is applied to PUCCH, beam for PUCCH for UE may be configured by RRC from the gNB to the UE (via the repeater). Thus, based on the beam configuration in the RRC and the relationship, at the repeater side, the beam for PUCCH transmission to the gNB for the gNB-repeater link and reception from the UE for the repeater-UE link can be determined. At the UE side, transmission beam of PUCCH in the UE can also be determined based on the indicated beam and the relationship.

When Scheme 3 is applied to PUSCH, beam for PUSCH for UE may be configured by PDCCH from the gNB to the UE (via the repeater). Thus, based on the signal resource indicator (SRI) in PDCCH and the relationship, the beam for PUSCH transmission for gNB-repeater link and reception in the repeater for repeater-UE link can be determined. The SRI in PDCCH is used to indicate the uplink beam. At the UE side, transmission beam of PUSCH in the UE can also be determined based on the indicated beam and the relationship.

For configured grant PUSCH, the beam is indicated in RRC configuration or activation DCI. In this case, combining the indicated beam information and the relationship, at the repeater side, beam for configured grant PUSCH transmission for the gNB-repeater link and reception in the repeater for the repeater-UE link can be determined. At the UE side, transmission beam of configured grant PUSCH in the UE can also be determined based on the indicated beam and the relationship.

Regarding PTRS or DMRS in the repeater and UE respectively, they will use the same beam(s) as the corresponding PUSCH or PUCCH.

When Scheme 3 is applied to PUCCH, beam(s) for UE may be configured by RRC from the gNB to the UE (via the repeater). Accordingly, based on the beam configuration in the RRC and the relationship, at the repeater side, the beam(s) for PUCCH transmission for the gNB-repeater link and reception in the repeater for the repeater-UE link can be determined. At the UE side, transmission beam(s) of PUCCH in the UE can also be determined based on the indicated beam and the relationship.

When Scheme 3 is applied to SRS, beam for UE is configured by RRC from the gNB to the UE (via the repeater). Thus, based on beam configuration in the RRC for SRS and the relationship, at the repeater side, the beam for SRS transmission for the gNB-repeater link and reception in the repeater for the repeater-UE link can be determined. At the UE side, transmission beam of SRS in the UE can also be determined based on the beam indicated and the relationship.

When Scheme 3 is applied to RACH or PRACH messages, beam(s) is related to the associated SSB or CSI-RS for the RO where Msg1 or msgA is to be transmitted. Thus, based on the configuration on at least one of time domain resource and frequency domain resource for RACH/PRACH message, the association between SSB or CSI-RS and RO, the SSB index or CSI-RS index for each RO can be determined. With the determined SSB or CSI-RS index and the relationship, beam(s) for RACH/PRACH message in the repeater for both the gNB-repeater link and repeater-UE link can be determined. At the UE side, transmission beam of RACH/PRACH message in the UE can be determined based on the associated SSB or CSI-RS index for each RO and the relationship. It can also be considered that beam(s) for the gNB-repeater link and repeater-UE link at the repeater side is determined based on the RO and the relationship. It can also be considered that beam(s) for UE is determined based on the RO and the relationship.

Besides the methods, embodiments of the present application also propose an apparatus of beam indication.

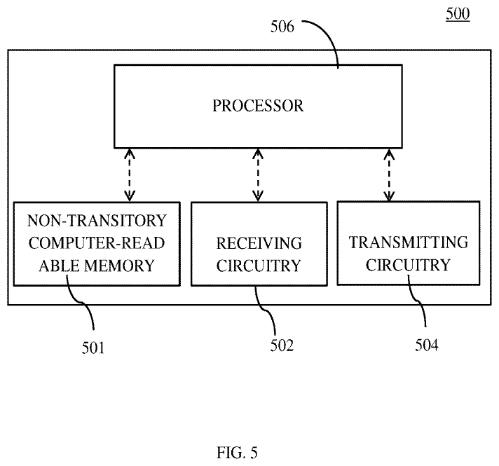

For example, FIG. 5 illustrates a block diagram of an apparatus of beam indication 500 according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The at least one processor 506 may be a CPU, a DSP, a microprocessor etc. The apparatus 500 may be a RAN node, e.g., a gNB or a repeater configured to perform a method illustrated in the above or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

In some embodiments of the present application, the non-transitory computer-readable medium 501 may have stored thereon computer-executable instructions to cause a processor to implement the method with respect to the first RAN node as described above. For example, the computer-executable instructions, when executed, cause the processor 506 interacting with receiving circuitry 502 and transmitting circuitry 504, so as to perform the steps with respect to the first RAN node as depicted above.

In some embodiments of the present application, the non-transitory computer-readable medium 501 may have stored thereon computer-executable instructions to cause a processor to implement the method with respect to the second RAN node as described above. For example, the computer-executable instructions, when executed, cause the processor 506 interacting with receiving circuitry 502 and transmitting circuitry 504, so as to perform the steps with respect to the second RAN node as illustrated above.

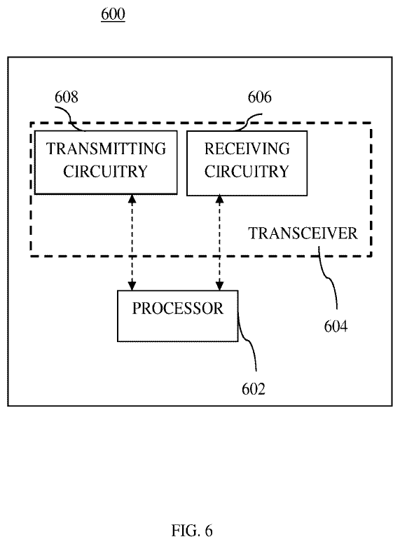

FIG. 6 is a block diagram of an apparatus of beam indication 600 according to some other embodiments of the present application.

Referring to FIG. 6, the apparatus 600, for example a gNB or a repeater may include at least one processor 602 and at least one transceiver 604 coupled to the at least one processor 602. The transceiver 604 may include at least one separate receiving circuitry 606 and transmitting circuitry 604, or at least one integrated receiving circuitry 606 and transmitting circuitry 604. The at least one processor 902 may be a CPU, a DSP, a microprocessor etc.

According to some embodiments of the present application, when the apparatus 600 is a repeater, the processor is configured to: receive, via the transceiver, at least first spatial domain filter configuration information from a second RAN node; and perform at least one of the following: downlink transmission to a remote apparatus at least according to a first spatial domain filter; downlink reception from the second RAN node at least according to a second spatial domain filter; uplink reception from the remote apparatus at least according to a third spatial domain filter; or uplink transmission to the second RAN node at least according to a fourth spatial domain filter; wherein each of the first, the second, the third and the fourth spatial domain filter is determined based on the first spatial domain filter configuration information, or determined based on received second spatial domain filter configuration information, or is determined based on a fifth spatial domain filter indicated in the first spatial domain filter configuration information and a relationship with the fifth spatial domain filter.

According to some other embodiments of the present application, when the apparatus 600 is a gNB, the processor may be configured to: determine at least one of the following: at least a first spatial domain filter for downlink communication from a first RAN node to a remote apparatus; at least a second spatial domain filter for downlink communication from the RAN node to the first RAN node; at least a third spatial domain filter for uplink communication from the remote apparatus to the first RAN node; or at least a fourth spatial domain filter for uplink communication from the first RAN node to the RAN node; and transmit, via the transceiver, at least first spatial domain filter configuration information to the first RAN node; wherein each of the first, the second, the third and fourth spatial domain filter is based on the first spatial domain filter configuration information, or based on transmitted second spatial domain filter configuration information, or is determined based on a fifth spatial domain filter indicated in the first spatial domain filter configuration information and a relationship with the fifth spatial domain filter.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A first radio access network (RAN) node, comprising:
at least one memory; and
at least one processor coupled with the at least one memory and configured to cause the first RAN node to:
receive at least first spatial domain filter configuration information from a second RAN node; and
perform at least one of:
downlink transmission to a remote apparatus at least according to a first spatial domain filter;
downlink reception from the second RAN node at least according to a second spatial domain filter;
uplink reception from the remote apparatus at least according to a third spatial domain filter; or
uplink transmission to the second RAN node at least according to a fourth spatial domain filter;
wherein each of the first, the second, the third and the fourth spatial domain filter is determined based on the first spatial domain filter configuration information, or determined based on received second spatial domain filter configuration information, or is determined based on a fifth spatial domain filter indicated in the first spatial domain filter configuration information and a relationship with the fifth spatial domain filter.

2. The first RAN node of claim 1, wherein the first spatial domain filter configuration information indicates both the first spatial domain filter and the second spatial domain filter.

3. The first RAN node of claim 1, wherein the first spatial domain filter configuration information indicates both the third spatial domain filter and the fourth spatial domain filter.

4. The first RAN node of claim 1, wherein the first spatial domain filter and the second spatial domain filter are indicated in different ones of the first spatial domain filter configuration information and the second spatial domain filter configuration information.

5. The first RAN node of claim 1, wherein the third spatial domain filter and the fourth spatial domain filter are indicated in different ones of the first spatial domain filter configuration information and the second spatial domain filter configuration information.

6. The first RAN node of claim 1, wherein the relationship is predefined or is configured by system information block (SIB), or radio resource control (RRC), or media access control (MAC) control element (CE) to the first RAN node.

7. The first RAN node of according to claim 1, wherein the fifth spatial domain filter is a downlink reception spatial domain filter configured by a signaling from the second RAN node to the remote apparatus, and the first spatial domain filter and the second spatial domain filter are determined based on a relationship with the fifth spatial domain filter.

8. The first RAN node of claim 1, wherein in a case that the first spatial domain filter, the second spatial domain filter and the fifth spatial domain filter are applied to synchronization signal (SS)/physical broadcast channel (PBCH) block (SSB), the first spatial domain filter, the second spatial domain filter and the fifth spatial domain filter are determined based on at least one time domain resource of the SSB.

9. The first RAN node of claim 1, wherein the fifth spatial domain filter is an uplink transmission spatial domain filter configured by a signaling from the second RAN node to the remote apparatus, and the third spatial domain filter and the fourth spatial domain filter are determined based on a relationship with the fifth spatial domain filter.

10. The first RAN node of claim 1, wherein in a case that the third spatial domain filter, the fourth spatial domain filter and the fifth spatial domain filter are applied to Msg1 or MsgA, the third spatial domain filter, the fourth spatial domain filter and the fifth spatial domain filter are determined based on corresponding time or frequency domain resource for Msg1 or MsgA and an association between channel state information-reference signal (CSI-RS) or synchronization signal (SS)/physical broadcast channel (PBCH) block (SSB) and random access channel (RACH) occasion (RO).

11. The first RAN node of claim 1, wherein in a case that there are a plurality of spatial domain filters including the second spatial domain filter for downlink reception by the first RAN node from the second RAN node and physical downlink shared channel (PDSCH) repetition is scheduled by physical downlink control channel (PDCCH), different PDSCH occasions are respectively associated with the plurality of spatial domain filters.

12. The first RAN node of claim 1, wherein the at least processor is further configured to cause the first RAN node to:
in a case that there are two or more spatial domain filters indicated in a signaling, receive an indication signaling indicating whether the two or more spatial domain filters are used for different links of the first RAN node or used for different resources in at least one of time domain, frequency domain or code domain for a link between the second RAN node and the first RAN node.

13. The first RAN node of claim 1, wherein in a case that there are two or more spatial domain filters indicated in a signaling used for different links of the first RAN node, the at least processor is further configured to cause the first RAN node to:
associate each spatial domain filter with each link between the first RAN node and the second RAN node, or between the first RAN node and the remote apparatus based on a predefined or configured rule.

14. A second radio access network (RAN) node, comprising:
at least one memory; and
at least one processor coupled with the at least one memory and configured to cause the second RAN node to:
determine at least one of:
at least a first spatial domain filter for downlink communication from a first RAN node to a remote apparatus;
at least a second spatial domain filter for downlink communication from the second RAN node to the first RAN node;
at least a third spatial domain filter for uplink communication from the remote apparatus to the first RAN node; or
at least a fourth spatial domain filter for uplink communication from the first RAN node to the second RAN node; node; and
transmit at least first spatial domain filter configuration information to the first RAN node;
wherein each of the first, the second, the third and the fourth spatial domain filter is based on the first spatial domain filter configuration information, or based on transmitted second spatial domain filter configuration information, or is determined based on a fifth spatial domain filter indicated in the first spatial domain filter configuration information and a relationship with the fifth spatial domain filter.

15. A method performed by a first radio access network (RAN) node, the method comprising:
receiving at least first spatial domain filter configuration information from a second RAN node; and
perform at least one of:
downlink transmission to a remote apparatus at least according to a first spatial domain filter;
downlink reception from the second RAN node at least according to a second spatial domain filter;
uplink reception from the remote apparatus at least according to a third spatial domain filter; or
uplink transmission to the second RAN node at least according to a fourth spatial domain filter;
wherein each of the first, the second, the third and the fourth spatial domain filter is determined based on the first spatial domain filter configuration information, or determined based on received second spatial domain filter configuration information, or is determined based on a fifth spatial domain filter indicated in the first spatial domain filter configuration information and a relationship with the fifth spatial domain filter.

16. The method of claim 15, wherein the first spatial domain filter configuration information indicates both the first spatial domain filter and the second spatial domain filter.

17. The method of claim 15, wherein the first spatial domain filter configuration information indicates both the third spatial domain filter and the fourth spatial domain filter.

18. The method of claim 15, wherein the first spatial domain filter and the second spatial domain filter are indicated in different ones of the first spatial domain filter configuration information and the second spatial domain filter configuration information.

19. The method of claim 15, wherein the third spatial domain filter and the fourth spatial domain filter are indicated in different ones of the first spatial domain filter configuration information and the second spatial domain filter configuration information.

20. A method performed by a second radio access network (RAN) node, the method comprising:
determining at least one of:
at least a first spatial domain filter for downlink communication from a first RAN node to a remote apparatus;
at least a second spatial domain filter for downlink communication from the second RAN node to the first RAN node;
at least a third spatial domain filter for uplink communication from the remote apparatus to the first RAN node; or
at least a fourth spatial domain filter for uplink communication from the first RAN node to the second RAN node; and
transmitting at least first spatial domain filter configuration information to the first RAN node;
wherein each of the first, the second, the third and the fourth spatial domain filter is based on the first spatial domain filter configuration information, or based on transmitted second spatial domain filter configuration information, or is determined based on a fifth spatial domain filter indicated in the first spatial domain filter configuration information and a relationship with the fifth spatial domain filter.
